(19) United States
(12) Patent Application Publication
(10) Pub. No.: US 2026/0156548 A1
(43) Pub. Date: Jun. 4, 2026

(54) METHODS, ARCHITECTURES, APPARATUSES AND SYSTEMS FOR LAYER 1/LAYER 2 TRIGGERED AND LAYER 3 TRIGGERED MOBILITY COEXISTENCE

(71) Applicant: InterDigital Patent Holdings, Inc., Wilmington, DE (US)

(72) Inventors: Brian Martin, Farnham (GB); Oumer Teyeb, Montreal (CA); Martino Freda, Laval, CA (US); Paul Marinier, Brossard (CA); Keiichi Kubota, Setagaya-Ku (JP)

(21) Appl. No.: 19/126,382

(22) PCT Filed: Nov. 1, 2023
(86) PCT No.: PCT/US2023/036597

§ 371 Date: May 1, 2025

Related U.S. Application Data
(60) Provisional application No. 63/421,822, filed on Nov. 2, 2022.

(51) Int. Cl. H04W 36/00; H04W 36/30

(52) U.S. Cl. CPC H04W 36/0088; H04W 36/00835; H04W 36/304

(57) ABSTRACT

Methods, apparatuses, systems, devices, and computer program products for L1/L2 inter-cell mobility and/or measurements are provided. One method may include performing measurements of a signal quality of a serving cell and, based on a first condition based on the signal quality of the serving cell being met, performing measurements of the signal quality of Layer 1/Layer 2 triggered mobility (LTM) candidate cells, performing an evaluation of the measurements of the LTM candidate cells using a first measurement evaluation method, and/or reporting using a first reporting method. Based on a second condition based on a signal quality of the LTM candidate cells being met, performing measurements of signal quality of cells outside of the set of LTM candidate cells, evaluation of the measurements of the cells outside of the set of LTM candidate cells using a second measurement evaluation method, and/or reporting using a second reporting method.

### CROSS-REFERENCE TO RELATED APPLICATIONS

This application claims the benefit of U.S. Provisional Patent Application No. 63/421,822, filed Nov. 2, 2022; the contents of this application is incorporated herein by reference in its entirety.

### FIELD

The present disclosure is generally directed to the fields of communications, software and encoding, including, for example, to methods, architectures, apparatuses, systems related to Layer 1 (L1 )/Layer 2 (L2 ) inter-cell mobility and/or measurements.

### SUMMARY

An embodiment may be directed to a wireless transmit/receive unit (WTRU) that may include circuitry, including any one or more of a transmitter, receiver, processor and/or memory. The circuitry is configured to receive information that indicates: a set of layer 1/layer 2 triggered mobility (LTM) candidate cells, a configuration of a first condition associated with a signal quality of a serving cell, and/or a configuration of a second condition associated with a signal quality of the LTM candidate cells. The circuitry is configured to perform measurements of the signal quality of the serving cell. Based on the first condition that is associated with a signal quality of the serving cell being satisfied, the circuitry is configured to perform any one or more of: measurements of the signal quality of the LTM candidate cells, a first measurement evaluation method of the measurements (e.g., performing an evaluation of the measurements of the LTM candidate cells using a first measurement evaluation method), and/or a first measurement reporting method (e.g., reporting the measurements using a first measurement reporting method). Based on the second condition that is associated with a signal quality of the LTM candidate cells being satisfied (e.g., when the first condition and the second condition are satisfied), the circuitry is configured to perform: measurements of signal quality of cells that are not in the set of the LTM candidate cells, a second measurement evaluation method of the measurements (e.g., performing an evaluation of the measurements of the non-LTM candidate cells using a second measurement evaluation method), and/or a second measurement reporting method (e.g., reporting the measurements of the non-LTM candidate cells using a second measurement reporting method). On condition that a radio quality condition based on the second measurement evaluation method is satisfied, the circuitry is configured to transmit a measurement report using the second reporting method.

An embodiment may be directed to a method that may be implemented by a WTRU. The method may include receiving information that indicates: a set of layer 1/layer 2 triggered mobility (LTM) candidate cells, a configuration of a first condition associated with a signal quality of a serving cell, and/or a configuration of a second condition associated with a signal quality of the LTM candidate cells. The method may include performing measurements of the signal quality of the serving cell. Based on the first condition that is associated with a signal quality of the serving cell being satisfied, the method may include performing any one or more of: measurements of the signal quality of the LTM candidate cells, a first measurement evaluation method of the measurements (e.g., performing an evaluation of the measurements of the LTM candidate cells using a first measurement evaluation method), and/or a first measurement reporting method (e.g., reporting the measurements using a first measurement reporting method). Based on the second condition that is associated with a signal quality of the LTM candidate cells being satisfied (e.g., when the first condition and the second condition are satisfied), the method may include performing: measurements of signal quality of cells that are not in the set of the LTM candidate cells, a second measurement evaluation method of the measurements (e.g., performing an evaluation of the measurements of the non-LTM candidate cells using a second measurement evaluation method), and/or a second measurement reporting method (e.g., reporting the measurements of the non-LTM candidate cells using a second measurement reporting method). On condition that a radio quality condition based on the second measurement evaluation method is satisfied, the method may include transmitting a measurement report using the second reporting method.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a high-level measurement model, according to an embodiment;

FIG. 3 illustrates an example handover (HO) scenario in NR, according to an embodiment;

FIG. 4 illustrates an example signaling diagram depicting conditional HO (CHO), according to one embodiment;

FIG. 5 illustrates an example of Layer 1/Layer 2 triggered mobility (LTM) operation, according to an embodiment; and

FIG. 6 illustrates an example flow diagram of a method, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

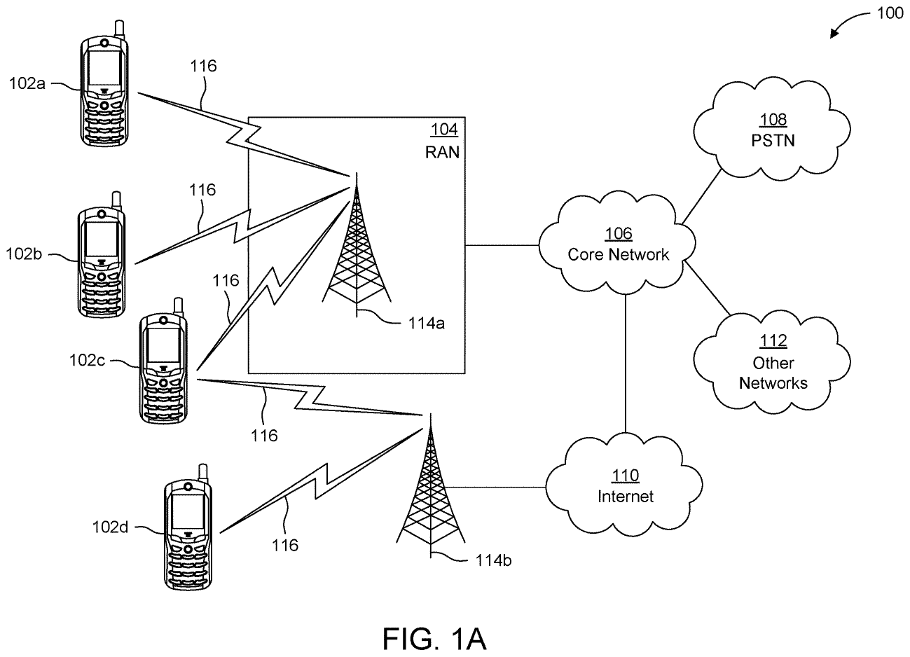

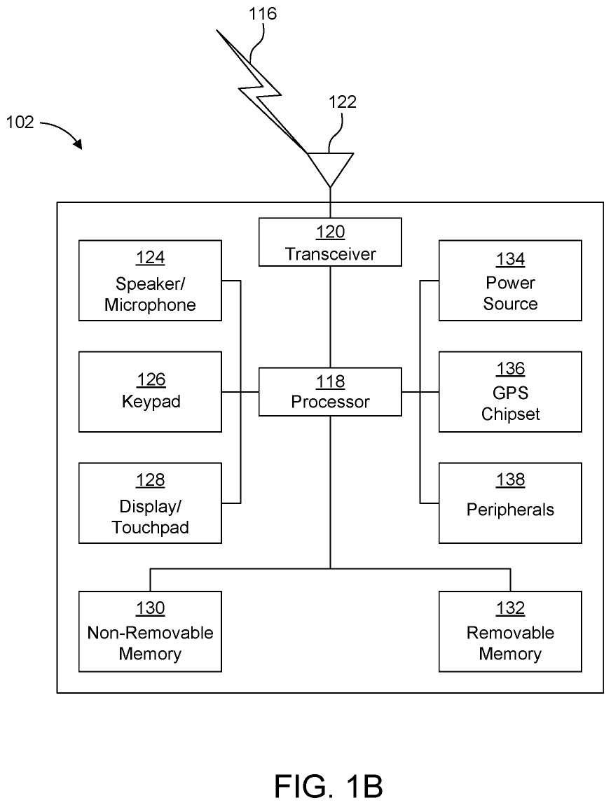

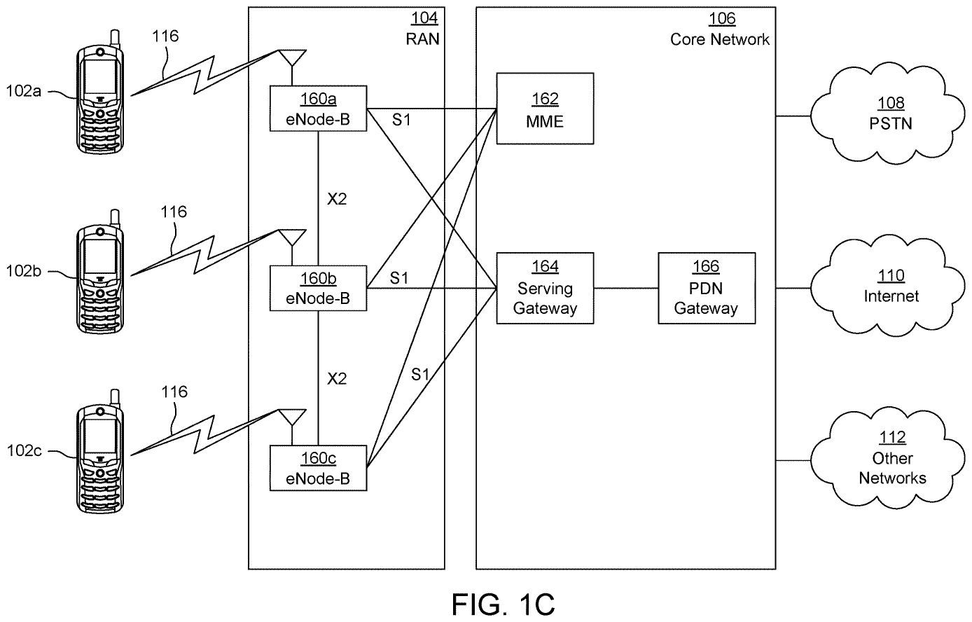

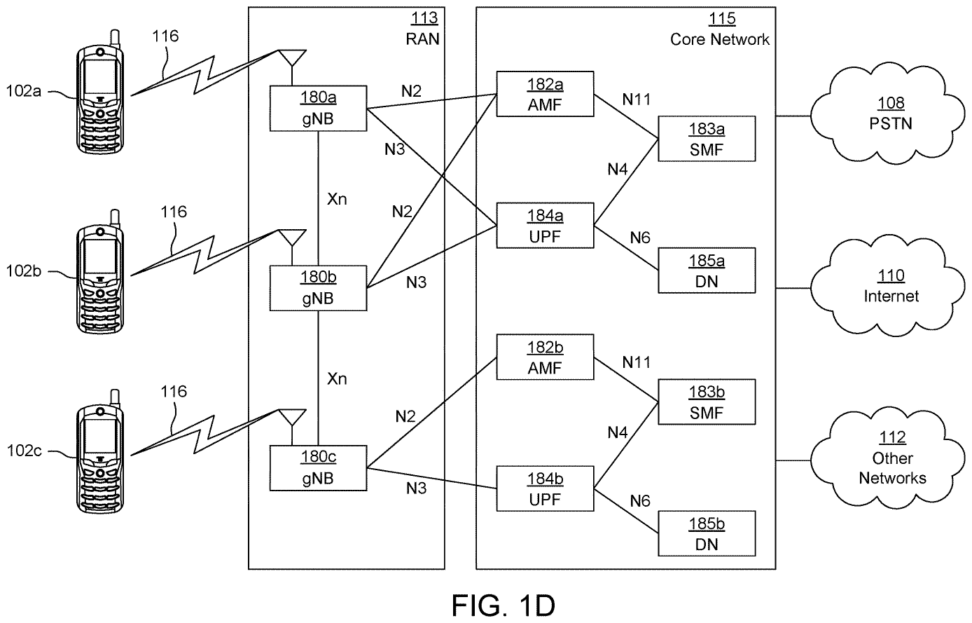

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

It is noted that, throughout example embodiments described herein, the terms “serving base station”, “base station”, “gNB”, collectively “gNB” may be used interchangeably to designate any network element such as, e.g., a network element acting as a serving base station. Embodiments described herein are not limited to gNBs and are applicable to any other type of base stations.

In RRC_CONNECTED state, the UE may measure multiple beams (at least one) of a cell and the measurements results (power values) are averaged to derive the cell quality. In doing so, the UE is configured to consider a subset of the detected beams. Filtering may take place at two different levels: at the physical layer to derive beam quality and at the radio resource control (RRC) level to derive cell quality from multiple beams. Cell quality from beam measurements can be derived in the same way for the serving cell(s) and for the non-serving cell(s). Measurement reports may contain the measurement results of the X best beams if the UE is configured to do so by the gNB.

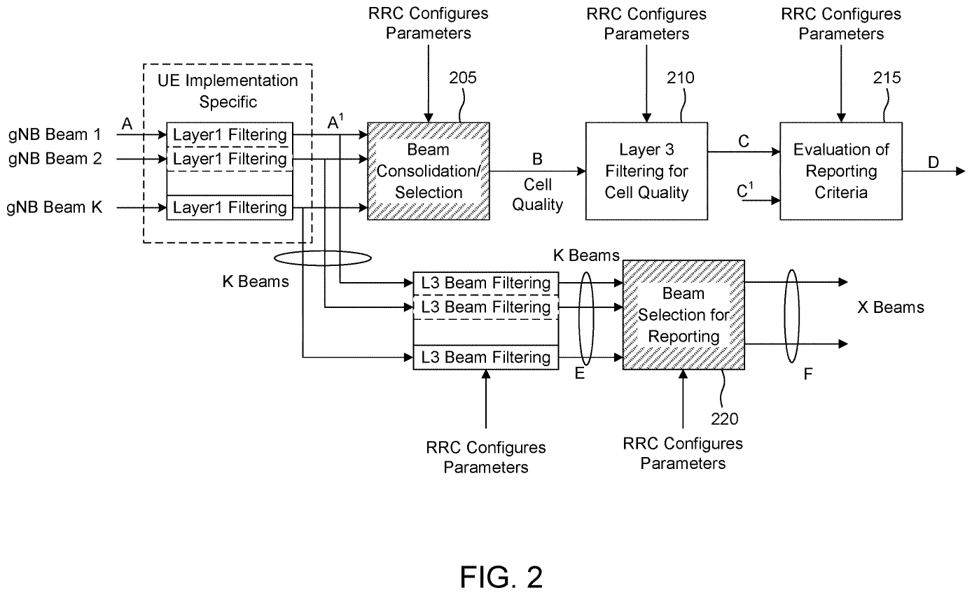

FIG. 2 illustrates an example of the corresponding high-level measurement model, according to an embodiment. As illustrated in the example of FIG. 2, at A, measurements (beam specific samples) internal to the physical layer may be performed. It is noted that, in this example, K beams correspond to the measurements on SSB or CSI-RS resources configured for L3 mobility by gNB and detected by UE at L1. In one example, internal layer 1 filtering of the inputs measured at point A may be performed. The exact filtering method may be implementation dependent. How the measurements are actually executed in the physical layer by an implementation (inputs A and Layer 1 filtering) is not constrained by the standard. At A1, measurements (i.e., beam specific measurements) may be reported by layer 1 to layer 3 after layer 1 filtering.

As illustrated in the example of FIG. 2, at 205, beam specific measurements may be consolidated to derive cell quality. The behaviour of the Beam consolidation/selection may be standardised and the configuration of this module can be provided by RRC signalling. Reporting period at B equals one measurement period at A1. At B, a measurement (i.e., cell quality) derived from beam-specific measurements may be reported to layer 3 after beam consolidation/selection. As illustrated at 210, layer 3 filtering (e.g., for cell quality) may be performed on the measurements provided at point B. The behaviour of the Layer 3 filters may be standardised and the configuration of the Layer 3 filters can be provided by RRC signalling. Filtering reporting period at C equals one measurement period at B. As illustrated at C, a measurement may be performed after processing in the Layer 3 filter. The reporting rate may be identical, or substantially similar, to the reporting rate at point B. This measurement may be used as input for one or more evaluation of reporting criteria.

In the example of FIG. 2, at 215, evaluation of reporting criteria may be performed to check whether actual measurement reporting is necessary at point D. The evaluation can be based on more than one flow of measurements at reference point C, e.g., to compare between different measurements. In FIG. 2, this is illustrated by input C and C1. The UE may evaluate the reporting criteria, for example, at least every time a new measurement result is reported at point C, C1. The reporting criteria may be standardised and the configuration can be provided by RRC signalling (UE measurements). As illustrated in the example of FIG. 2 at D, measurement report information (message) may be sent on the radio interface. Then, L3 beam filtering may be performed on the measurements (i.e., beam specific measurements) provided at point A1. The behaviour of the beam filters may be standardised and the configuration of the beam filters can be provided by RRC signalling. The filtering reporting period at E equals one measurement period at A1. At E, a measurement (i.e., beam-specific measurement) after processing in the beam filter may be performed. The reporting rate may be identical, or substantially similar, to the reporting rate at point A1. This measurement may be used as input for selecting the X measurements to be reported. At 220, beam Selection for beam reporting may be performed to select the X measurements from the measurements provided at point E. The behaviour of the beam selection may be standardised and the configuration of this module can be provided by RRC signalling. As shown at F, beam measurement information may be included in a measurement report (sent) on the radio interface.

Layer 1 filtering introduces a certain level of measurement averaging. How and when the UE exactly performs the required measurements is implementation specific to the point that the output at B fulfils the performance requirements set in 3GPP TS 38.133. Layer 3 filtering for cell quality and related parameters used are specified in TS 38.331 and do not introduce any delay in the sample availability between B and C. C1 is the input used in the event evaluation. L3 Beam filtering and related parameters used are specified in TS 38.331 and do not introduce any delay in the sample availability between E and F.

Measurement reports may be characterized by one or more of the following: measurement reports include the measurement identity of the associated measurement configuration that triggered the reporting; cell and beam measurement quantities to be included in measurement reports are configured by the network; the number of non-serving cells to be reported can be limited through configuration by the network; cells belonging to an exclude-list configured by the network are not used in event evaluation and reporting, and conversely when an allow-list is configured by the network, only the cells belonging to the allow-list are used in event evaluation and reporting; and/or beam measurements to be included in measurement reports are configured by the network (beam identifier only, measurement result and beam identifier, or no beam reporting).

Intra-frequency neighbour (cell) measurements and inter-frequency neighbour (cell) measurements may be defined as follows:
Synchronization signal block (SSB) based intra-frequency measurement: a measurement is defined as an SSB based intra-frequency measurement provided the center frequency of the SSB of the serving cell and the center frequency of the SSB of the neighbour cell are the same, and the subcarrier spacing of the two SSBs is also the same; and/or
SSB based inter-frequency measurement: a measurement is defined as an SSB based inter-frequency measurement provided the center frequency of the SSB of the serving cell and the center frequency of the SSB of the neighbour cell are different, or the subcarrier spacing of the two SSBs is different.

It is noted that, for SSB based measurements, one measurement object corresponds to one SSB and the UE considers different SSBs as different cells.

Channel state information reference signal (CSI-RS) based intra-frequency measurement may refer to a measurement that is defined as a CSI-RS based intra-frequency measurement provided that:
The subcarrier spacing of CSI-RS resources on the neighbour cell configured for measurement is the same as the subcarrier spacing (SCS) of CSI-RS resources on the serving cell indicated for measurement; and
For 60 kHz subcarrier spacing, the cyclic prefix (CP) type of CSI-RS resources on the neighbour cell configured for measurement is the same as the CP type of CSI-RS resources on the serving cell indicated for measurement; and
The center frequency of CSI-RS resources on the neighbour cell configured for measurement is the same as the center frequency of CSI-RS resource on the serving cell indicated for measurement.

CSI-RS based inter-frequency measurement may refer to a measurement that is defined as a CSI-RS based inter-frequency measurement if it is not a CSI-RS based intra-frequency measurement. Whether a measurement is non-gap-assisted or gap-assisted depends on the capability of the UE, the active bandwidth part (BWP) of the UE and the current operating frequency. For SSB based inter-frequency measurement, if the measurement gap requirement information is reported by the UE, a measurement gap configuration may be provided according to the information. Otherwise, a measurement gap configuration is provided (e.g., always provided) in the following cases: if the UE only supports per-UE measurement gaps, and/or if the UE supports per-FR measurement gaps and any of the serving cells are in the same frequency range of the measurement object. For SSB based intra-frequency measurement, if the measurement gap requirement information is reported by the UE, a measurement gap configuration may be provided according to the information. Otherwise, a measurement gap configuration is provided (e.g., always provided) in the following case: other than the initial BWP, if any of the UE configured BWPs do not contain the frequency domain resources of the SSB associated to the initial DL BWP. In non-gap-assisted scenarios, the UE may be able to carry out such measurements without measurement gaps. In gap-assisted scenarios, the UE cannot be assumed to be able to carry out such measurements without measurement gaps.

Channel state information (CSI) may be used as an indicator from the UE to the network on how good (or bad) a channel is at any point in time. CSI may be used by the gNB to make scheduling decisions such as selection of Modulation and Coding Scheme (MCS) and to assist with beamforming. According to TS 38.214, the time and frequency resources that can be used by the UE to report CSI are controlled by the gNB. CSI may comprise a Channel Quality Indicator (CQI), a precoding matrix indicator (PMI), a CSI-RS resource indicator (CRI), a SS/PBCH Block Resource indicator (SSBRI), a layer indicator (LI), a rank indicator (RI), L1-reference signal received power (RSRP), L1-signal-to-interference noise ratio (SINR) and/or Capability[Set]Index.

For CQI, PMI, CRI, SSBRI, LI, RI, L1-RSRP, L1-SINR, and/or Capability[Set]Index, a UE may be configured by higher layers with N≥1 CSI-ReportConfig Reporting Settings, M≥1 CSI-ResourceConfig Resource Settings, and one or two list(s) of trigger states (e.g., given by the higher layer parameters CSI-Aperiodic Trigger StateList and CSI-SemiPersistentOnPUSCH-TriggerStateList). Each trigger state in CSI-AperiodicTriggerStateList may contain a list of associated CSI-ReportConfigs indicating the Resource Set IDs for channel and optionally for interference. Each trigger state in CSI-SemiPersistentOnPUSCH-TriggerStateList may contain one associated CSI-ReportConfig.

Each Reporting Setting CSI-ReportConfig may be associated with a single downlink BWP (e.g., indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSB Resource Indicator(SSBRI) and Capability[Set]Index.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related or Capability [Set]Index-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, or Further Enhanced Type II Port Selection including codebook subset restriction when applicable, and configurations of group-based reporting.

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting may be located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resource Type and can be set to aperiodic, periodic, or semi-persistent. For periodic and semi-persistent CSI Resource Settings, when the UE is configured with groupBasedBeamReporting-r17, the number of CSI Resource Sets configured is S=2; otherwise the number of CSI-RS Resource Sets configured is limited to S=1. For periodic and semi-persistent CSI Resource Settings, the configured periodicity and slot offset is given in the numerology of its associated DL BWP, as given by BWP-id. When a UE is configured with multiple CSI-ResourceConfigs comprising the same NZP CSI-RS resource ID, the same time domain behavior shall be configured for the CSI-ResourceConfigs. When a UE is configured with multiple CSI-ResourceConfigs comprising the same CSI-IM resource ID, the same time-domain behavior may be configured for the CSI-ResourceConfigs. All CSI Resource Settings linked to a CSI Report Setting may have the same time domain behavior.

The following may be configured via higher layer signaling for one or more CSI Resource Settings for channel and interference measurement: CSI-IM resource for interference measurement as described in TS 38.214 Clause 5.2.2.4; NZP CSI-RS resource for interference measurement as described in TS 38.214 Clause 5.2.2.3.1; and/or NZP CSI-RS resource for channel measurement as described in TS 38.214 Clause 5.2.2.3.1.

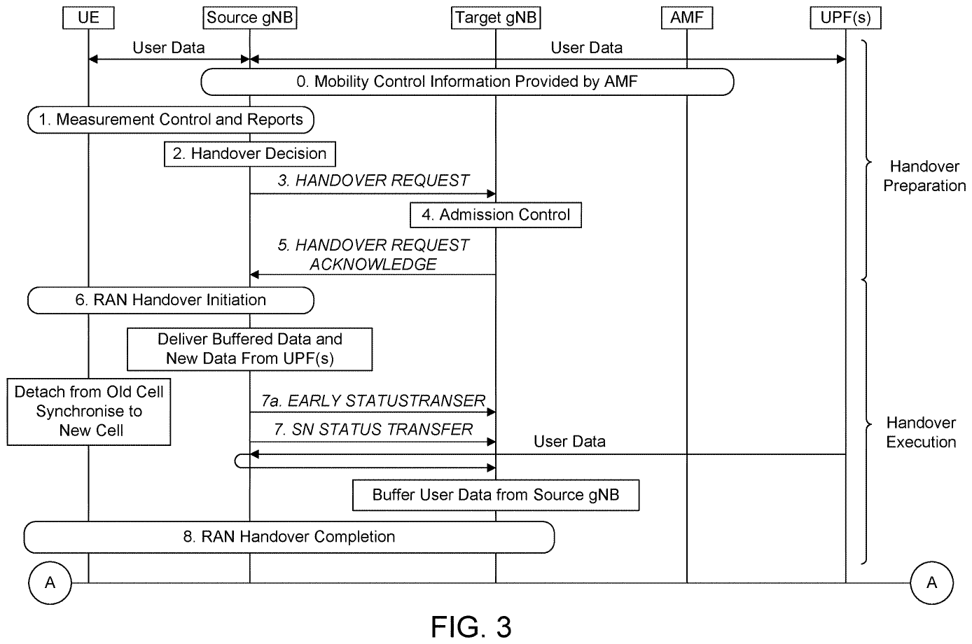

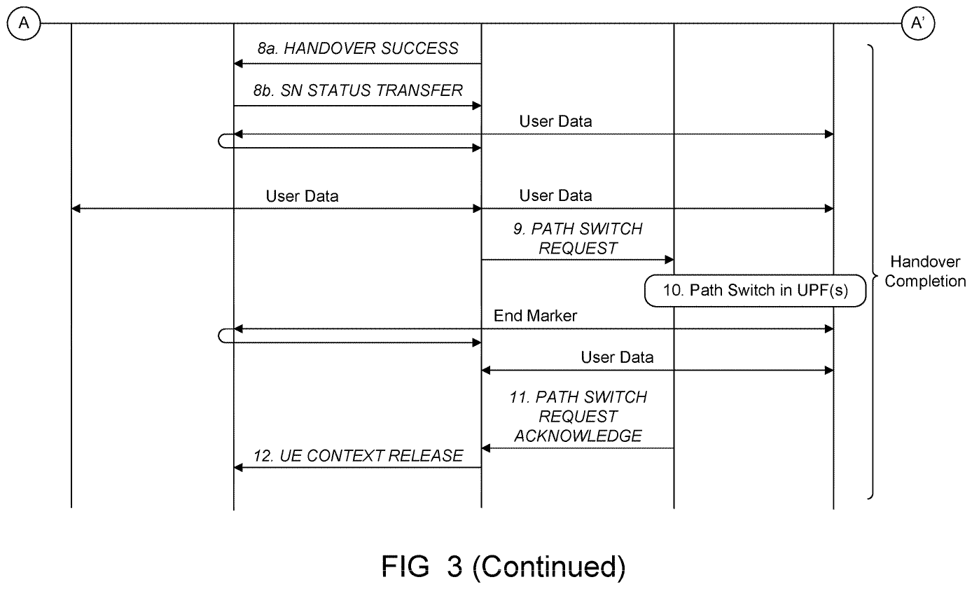

FIG. 3 illustrates an example handover (HO) scenario in NR. In the example of FIG. 3, at 0, the UE context within the source gNB contains information regarding roaming and access restrictions which were provided either at connection establishment or at the last Timing Advance (TA) update. At 1, the source gNB configures the UE measurement procedures and the UE reports according to the measurement configuration. At 2, the source gNB decides to handover the UE, based on the received measurements. At 3, the source gNB issues a Handover Request message to the target gNB passing a transparent RRC container with necessary information to prepare the handover at the target side. The information may include at least the target cell ID, KgNB*, the C-RNTI of the UE in the source gNB, RRM-configuration including UE inactive time, basic AS-configuration including antenna Info and DL Carrier Frequency, the current QoS flow to data radio bearers (DRB) mapping rules applied to the UE, the SIB1 from source gNB, the UE capabilities for different RATs, PDU session related information, and can include the UE reported measurement information including beam-related information if available.

As further illustrated in the example of FIG. 3, at 4, Admission Control may be performed by the target gNB. At 5, if the UE can be admitted, the target gNB prepares the handover with L1/L2 and sends the HANDOVER REQUEST ACKNOWLEDGE to the source gNB, which includes a transparent container to be sent to the UE as an RRC message to perform the handover. At 6, the source gNB triggers the Uu handover by sending an RRCReconfiguration message to the UE, containing the information required to access the target cell, such as: at least the target cell ID, the new cell radio network temporary identifier (C-RNTI), and/or the target gNB security algorithm identifiers for the selected security algorithms. It can also include a set of dedicated RACH resources, the association between random access channel (RACH) resources and SSB(s), the association between RACH resources and UE-specific CSI-RS configuration(s), common RACH resources, and system information of the target cell, etc.

In the example of FIG. 3, at 7, the source gNB sends the SN STATUS TRANSFER message to the target gNB to convey the uplink packet data convergence protocol (PDCP) sequence number (SN) receiver status and the downlink PDCP SN transmitter status of DRBs for which PDCP status preservation applies (i.e., for RLC AM). AT 8, the UE synchronises to the target cell and completes the RRC handover procedure by sending RRCReconfigurationComplete message to target gNB. At 9, the target gNB sends a PATH SWITCH REQUEST message to AMF to trigger 5GC to switch the DL data path towards the target gNB and to establish an NG-C interface instance towards the target gNB. At 10, 5GC switches the DL data path towards the target gNB. The UPF sends one or more “end marker” packets on the old path to the source gNB per PDU session/tunnel and then can release any U-plane/TNL resources towards the source gNB. At 11, the AMF confirms the PATH SWITCH REQUEST message with the PATH SWITCH REQUEST ACKNOWLEDGE message. At 12, upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

Rel-16 NR introduced the concept of conditional handover (CHO) and conditional Primary Secondary serving Cell (PSCell) Addition/Change (CPA/CPC, or collectively referred to as CPAC), with the main aim of reducing the likelihood of radio link failures (RLF) and handover failures (HOF).

Legacy LTE or NR handover is typically triggered by measurement reports, even though there is nothing preventing the network from sending a HO command to the UE even without receiving a measurement report. For example, the UE may be configured with an A3 event that triggers a measurement report to be sent when the radio signal level/quality (RSRP, RSRQ, etc) of a neighbor cell becomes better than the Primary serving cell (PCell) or also the Primary Secondary serving Cell (PSCell), in the case of Dual Connectivity (DC). The UE monitors the serving and neighbor cells and will send a measurement report when the conditions get fulfilled. When such a report is received, the network (current serving node/cell) will prepare the HO command (basically, an RRC Reconfiguration message, with a reconfiguration WithSync) and sends it to the UE, which the UE executes (e.g., executes immediately) resulting in the UE connecting to the target cell.

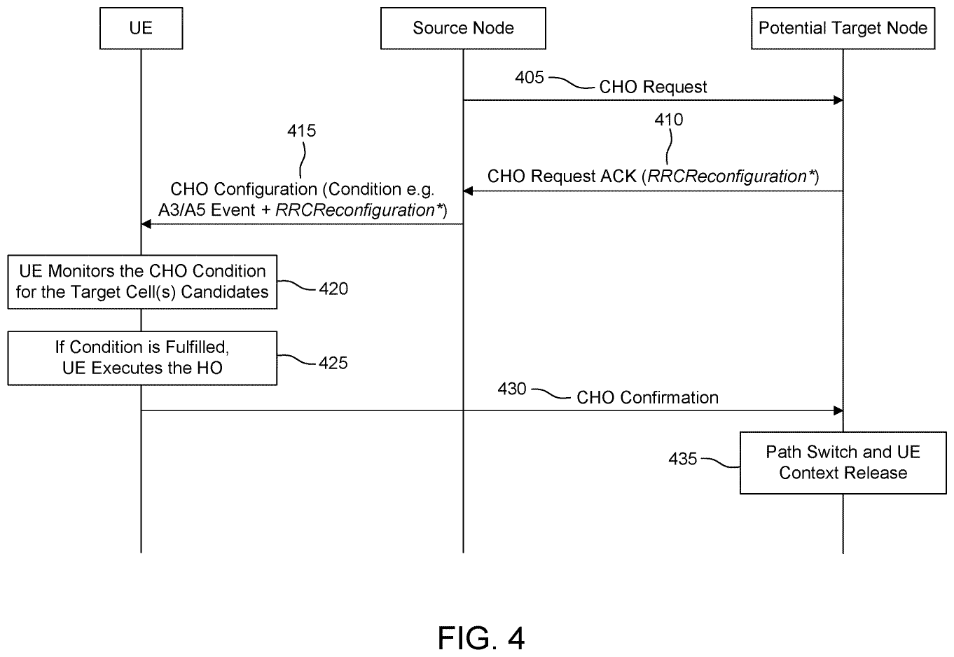

FIG. 4 illustrates an example signaling diagram depicting CHO, according to one example. At 405, a source node may send a CHO request to a potential target node. At 410, the potential target node may send a CHO request ACK (e.g., with RRCReconfiguration) to the source node. At 415, the source node may send a CHO configuration (e.g., including a CHO condition, such as an A3/A5 event, and the RRCReconfiguration) to the UE. At 420, the UE may monitor for the CHO condition for the candidate target cell(s), and if/when the condition is fulfilled, at 425, the UE may execute the HO. At 430, the UE may send a CHO confirmation to the target node, which may perform path switch and UE context release, as shown at 435.

CHO differs from legacy handover in some aspects. For example, in CHO, multiple handover targets are prepared (as compared to only one target in legacy case). Additionally, in CHO, the UE does not immediately execute the CHO as in the case of the legacy handover. Instead, the UE is configured with triggering conditions a set of radio conditions, and the UE executes the handover towards one of the targets only when/if the triggering conditions are fulfilled.

The CHO command could be sent when the radio conditions towards the current serving cells are still favorable, thereby reducing the two main points of failure in legacy handover, i.e., risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the UE has sent the measurement report, but before it has received the HO command). The triggering conditions for a CHO could also be based on the radio quality of the serving cells and neighbor cells like the conditions that are used in legacy NR/LTE to trigger measurement reports. For example, the UE could be configured with a CHO that has an A3 like triggering conditions and associated HO command. The UE monitors the current and serving cells and when the A3 triggering conditions are fulfilled, it will, instead of sending a measurement report, executes the associated HO command and switches its connection towards the target cell.

Another benefit of CHO is in helping prevent unnecessary re-establishments in case of a radio link failure (RLF). For example, assume the UE is configured with multiple CHO targets and the UE experiences an RLF before the triggering conditions with any of the targets gets fulfilled. Legacy operation would have resulted in RRC re-establishment procedure that would have incurred considerable interruption time for the bearers of the UE. However, in the case of CHO, if the UE, after detecting an RLF, ends up a cell for which it has a CHO associated with (i.e., the target cell is already prepared for it), the UE will execute the HO command associated with this target cell directly, instead of continuing with the full re-establishment procedure.

Conditional PSCell Change (CPC) and Conditional PSCell Addition (CPA) are extensions of CHO, but in dual connectivity (DC) scenarios. A UE could be configured with triggering conditions for PSCell change or addition, and when the triggering conditions are fulfilled, the UE will execute the associated PSCell change or PSCell add commands.

Currently, in Rel17, inter-cell beam management can be used to manage the beams in carrier aggregation (CA) case, but no cell change/add is currently supported. In Rel18, one of the objectives of the work item, “Further NR Mobility Enhancements” is to specify mechanism and procedures of L1/L2 based inter-cell mobility for mobility latency reduction. This may include one or more of the following: the configuration and maintenance for multiple candidate cells to allow for the fast application of configurations for candidate cells, dynamic switching mechanisms among candidate serving cells for the potential applicable scenarios based on L1/L2 signalling, L1 enhancements for inter-cell beam management including L1 measurement/reporting and beam indication, timing advance management, and centralized unit (CU)-distributed unit (DU) interface signalling to support L1/L2 mobility if needed. It is noted that L1/L2 based inter-cell mobility may be applicable, for example, to the following:
Standalone, CA and NR-DC case with serving cell change within one CG;
Intra-DU case and intra-CU inter-DU case (e.g., applicable for standalone and CA, where no new RAN interfaces are expected);
Both intra-frequency and inter-frequency;
Both frequency range 1 (FR1) and frequency range 2 (FR2);
Source and target cells may be synchronized or non-synchronized;
Inter-CU case is not included.

L1/L2 based mobility was originally introduced in Rel17, and inter-cell beam management in Rel17 addresses intra-DU and intra-frequency scenarios. In this case, the serving cell remains unchanged (i.e., there is no possibility to change the serving cell using L1/2 based mobility). In FR2 deployments, CA is typically used in order to exploit the available bandwidth, e.g., to aggregate multiple CCs in one band. These CCs are typically transmitted with the same analog beam pair (gNB beam and UE beam). The UE is configured with transmission configuration indicator (TCI) states (can have fairly large number, e.g., 64) for reception of physical downlink control channel (PDCCH) and physical downlink shared channel (PDSCH). Each TCI state includes a reference signal (RS) or SSB that the UE refers to for setting its beam. For Rel17, the SSB can be associated with a non-serving physical cell ID (PCI). Medium access control (MAC) signaling (“TCI state indication for UE-specific PDCCH MAC CE”) activates the TCI state for a CORESET/PDCCH. Reception of PDCCH from a non-serving cell is supported by MAC control element (CE) indicating a TCI state associated to non-serving PCI. MAC signaling (“TCI States Activation/Deactivation for UE-specific PDSCH”) activates a subset of (up to) 8 TCI states for PDSCH reception. DCI indicates which of the 8 TCI states. Rel17 also supports “unified TCI state” with a different updating mechanism (DCI-based), but without multi-TRP. Rel18 will support unified TCI state with multi-TRP.

An overall objective of inter-cell L1/L2 triggered mobility (LTM) is to improve handover latency; with a conventional L3 handover or conditional the UE will typically first send a measurement report using RRC signalling. In response to this, the network may provide a further measurement configuration and potentially a conditional handover configuration. With a conventional handover, the network provides a configuration for a target cell after the UE reports using RRC signalling that the cell meets a configured radio quality criteria. With conditional handover, in order to reduce the handover failure rate due to the delay in sending a measurement report then receiving an RRC reconfiguration the network provides, in advance, a target cell configuration as well as a measurement criteria which determines when the UE should trigger the CHO configuration. Both of these L3 methods, however, can suffer from some amount of delay due to the sending of measurement reports and receiving of target configurations, particularly in case of the conventional (non-conditional) handover.

In particular, the aim of LTM is to allow a fast application of configurations for candidate cells, including dynamically switching between SCells and switching of the PCell (e.g., switch the roles between SCell and PCell) without performing RRC signalling. The inter-CU case is not included, as this requires relocation of the PDCP anchor and has already been excluded from the work item. Therefore, an RRC based approach is needed at least to support inter-CU handover.

Furthermore, with the legacy L3 handover mechanisms, any currently active SCell(s) are released before the UE completes the handover to a target cell in the coverage area of a new site, and can only be added back after successful handover, which leads to throughput degradation during handover. One of the aims of L1/2 is therefore to enable CA operation to be enabled instantaneously upon serving cell change.

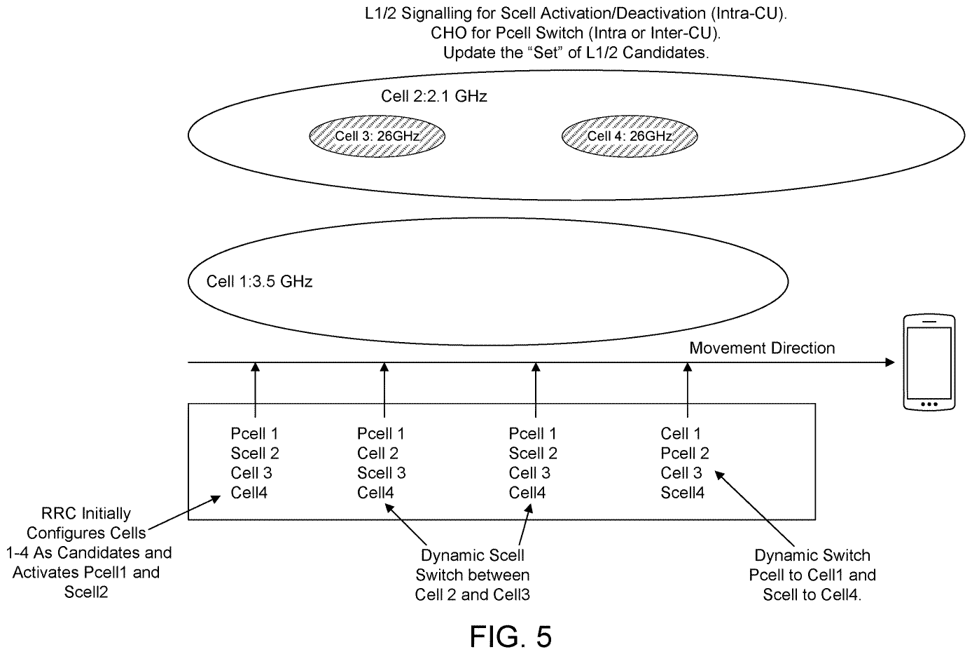

FIG. 5 illustrates an example of LTM operation, according to an embodiment. As illustrated in the example of FIG. 5, the candidate cell group may be configured by RRC and a dynamic switch of PCell and SCell is achieved using L1/L2 signalling. More specifically, in the example of FIG. 5, RRC may initially configure cells 1-4 as candidates and activates PCell1 and SCell2. Additionally, as shown in FIG. 5, dynamic SCell switch may be performed between Cell2 and Cell3, and dynamic switch of PCell to Cell1 and SCell to Cell4.

As mentioned above, the inter-CU case is not included, as this requires relocation of the PDCP anchor and has already been excluded from the work item. Therefore, an RRC based approach is desirable at least to support inter-CU handover. This implies that when LTM is configured, along with measurement and measurement reporting mechanisms to support LTM, it needs to run in parallel, or coexist, with RRC based measurements and mobility.

For LTM, it is assumed in 3GPP that L1 measurements will be used at least for making the cell switch decision. Various solutions are being considered including use of L1 measurements alone, and using L3 measurements to support enabling L1 measurements-for example, performing the candidate cell detection/measurements using L3 measurements, and configuring or enabling L1 measurements and reporting once a candidate cell meets a particular condition such as a radio quality threshold to enable faster measurement triggering and handover.

It is also assumed in 3GPP that some of the L2 reconfiguration procedures may be avoided when performing LTM (i.e., a cell change). Since LTM supports intra-DU cell change, for these cases the UE may not need to perform a full MAC reset since the MAC resides in the DU part of the network and hence the MAC configuration and storing of PDUs in the transmission/retransmission buffers may be maintained during a change of cell when both cells belong to the same DU. Similarly, for both the intra-DU and inter-DU case, only intra-CU cell change will be supported in LTM—for this case, RLC and PDU re-establishment may not be necessary since these reside in the CU part of the network and therefore the configuration and storing of PDUs in the transmission/retransmission buffers may be maintained during a change of cell when both cells belong to the same CU. Additionally, it is assumed that no change of security keys needs to be performed for LTM since the cell change is limited to cells within the same CU. Reducing the amount of reconfiguration that needs to be performed, as well as other potential enhancements such as performing DL and/or UL synchronisation before the reconfiguration also improves handover interruption time, allowing for improved mobility performance at least for the cell changes which occur within the same CU or the same DU using LTM.

Due to the enhancements explained above (i.e., faster measurement triggers, reduced latency of handover, reduced handover interruption, reduced RRC reconfiguration), when LTM is configured it is better for the UE to perform mobility within the configured set of LTM candidate cells for as long as possible and only perform inter-CU handover (which has an associated additional overhead in terms of reconfiguration effort, handover interruption, and so on) when moving out of coverage of the current CU or the current LTM candidate set.

In addition, since LTM may be under the control of the DU (e.g., for intra-DU mobility) while L3 mobility is controlled by the CU, there may be cases where there is a race condition, for example the DU and the CU each initiate a cell change/reconfiguration at approximately the same time. As an example, the CU may transmit an RRC reconfiguration to the UE which may be sent using radio link control (RLC) PDUs and MAC PDUs, and the DU may transmit a MAC CE to trigger cell change while the RRC Reconfiguration is being transmitted.

Accordingly, certain embodiments provide solutions for how to ensure preferential mobility within the LTM candidate set (e.g., within the same CU, using L1/L2 triggered reconfiguration) over mobility outside of the LTM candidate set (e.g., inter-CU, using L3 triggered reconfiguration. Additionally, example embodiments, can minimize collision between LTM and L3 mobility (L3M).

An embodiment may provide separate conditions for performing LTM measurement and for performing L3 intra-frequency and inter-frequency measurements (on cells outside of the LTM candidate set). The condition for L3 measurement may take into account the radio quality of the cells inside of the LTM candidate set.

For instance, in certain embodiments, a UE may monitor the signal quality of the serving cell. When a radio quality condition based on the serving cell measurement(s) is met (e.g., PCell goes below threshold1), the UE may perform one or more of the following: measurements on cells within the LTM candidate set, evaluation of the measurements using a first measurement evaluation method (e.g., LTM specific measurement events performed on cells inside the set), and/or reporting using a first reporting method (e.g., reporting using MAC CE).

According to some embodiments, when certain radio quality condition based on the signal quality of the serving cell and/or LTM candidate cell(s) is met, the UE may perform (e.g., enable) one or more of the following: measurements on cells outside of the LTM candidate set, evaluation of the measurements using a second measurement evaluation method (e.g., RRC measurement events), and/or reporting using a second reporting method (e.g., RRC measurement event).

In an embodiment, when a radio quality condition based on the second measurement evaluation method is met, a measurement report using the second reporting method may be triggered.

An embodiment may provide a measurement event which is triggered when a condition is met for the serving cell and cells inside of the LTM candidate set, and a cell outside of the LTM set is above a threshold (e.g., similar to event A5 but using not only the SpCell but also other candidate cells). According to certain embodiments, the UE may (e.g., may be configured to) perform measurements on the set of cells within the LTM set, derive a first signal quality based on the measurements, and evaluate the signal quality based on a first condition. In an embodiment, the UE may (e.g., may be configured to) perform measurements on cells outside of the LTM set, derive a second signal quality, and evaluate the signal quality based on a second condition. When the first and the second conditions are met (e.g., simultaneously met), a measurement report may be triggered.

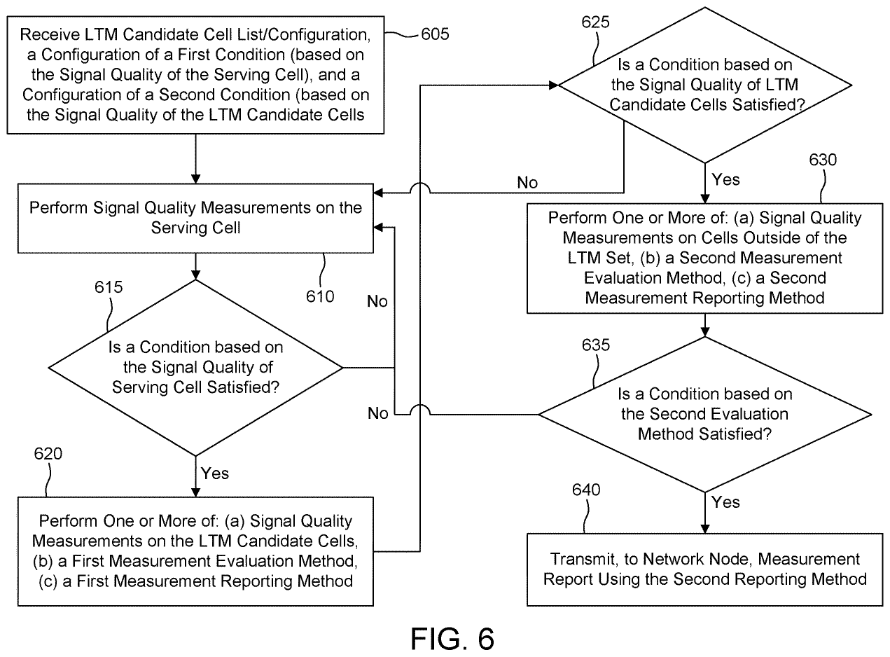

FIG. 6 illustrates a flow diagram of a method, according to an example embodiment. According to certain embodiments, the method of FIG. 6 may be implemented by a UE or WTRU. In the example method of FIG. 6, at 605, the UE may receive a configuration for LTM candidate cells. This configuration may include a list of cell IDs (e.g., PCI), a list of measurement resources (e.g. SSB or CSI-RS), and may include a configuration to apply when the UE receives an indication using MAC CE or DCI in indicating to change cell. The UE may also receive a configuration for cells outside of the candidate set, for example a neighbour list. In addition to candidate cell and neighbour cell configurations, the UE may also receive, at 605, a configuration of a (e.g. a first) condition based on the signal quality of the serving cell and a configuration of a (e.g. a second) condition based on the signal quality of the LTM candidate cells which would be evaluated. The first condition may be, for example, a (e.g., first) signal quality threshold (e.g., s-measure) which is used to trigger measurements on LTM candidate cells, and a first measurement evaluation method which uses a first reporting method, when the signal quality of the serving cell measured at 610 goes below the configured threshold in step 615. This allows power saving at the UE, since measurements of candidate cells may not be required while the serving cell quality is relatively high. This first threshold would be applied as a trigger for measurements of cells within the LTM candidate set. The first threshold may be used to trigger evaluation of LTM candidate cells. For instance, it may be used to perform LTM measurement event evaluations, for example a measurement event configured such that when the (e.g., L3) event criteria is met this enables (e.g. L1) CSI reporting. The first threshold may be used to trigger L1 CSI measurements to be used for LTM cell change decisions.

In addition to the (e.g., first) condition based on the signal quality of the serving cell, the UE may receive, at 605, a configuration of a separate (e.g., second) condition which is based on the signal quality of LTM candidate cells measured at 620 to be evaluated in step 625. This second condition may be, for example, a (e.g., second) signal quality threshold (e.g., s-Measure) which is used to trigger measurements on cells outside of the candidate set, and a second measurement evaluation method using a second reporting method, in step 630, when the signal quality of one (e.g., the serving) or more (e.g. all) of the LTM candidate cells go below the threshold.

In an embodiment, the UE may, for example, perform RRC measurement event evaluation using the second evaluation method in step 635 and send a measurement event using the second reporting method at 640 when an event is triggered based on measurements of cells outside of the LTM set.

According to certain embodiments, the measurements and evaluation of cells outside of the LTM set may be triggered when one or more of the following occurs:
a) PCell goes below threshold 2 (threshold 2<threshold1);
b) PCell signal has dropped by more than a certain threshold within a given time;
c) All the LTM candidate cells are below a certain threshold (where the threshold can be the same for all or each candidate cell has a threshold associated with it);
d) The average signal level of all the LTM candidate cells is below a certain threshold;
e) The signal level of all the LTM candidate cells is decreasing (e.g., by a certain threshold within a given time); and/or
f) Any of the above conditions are met for a minimum time period (e.g., a time to trigger).

Certain example embodiments may provide separate s-Measure thresholds for controlling measurements and evaluation on cells inside and outside of the LTM candidate set. In one embodiment, both the first and the second threshold may be compared to the serving cell quality (e.g., measurements on LTM candidate cells started when PCell falls below threshold1, measurements on non LTM candidate cells started when PCell falls further below threshold2). In this case, the first threshold may be set to a higher value than the second threshold. The first threshold may trigger measurements on cells within the LTM candidate set and may trigger evaluation of measurement events associated with LTM candidate cells, which may result in the UE sending a MAC CE measurement report and receiving a MAC CE triggering a cell change. The second threshold may be used to trigger measurements outside of the LTM candidate set (e.g., in addition to measurements of cells within the LTM candidate set). The second threshold may be used to control when the UE starts evaluating measurement events associated with L3 mobility, which may result in the UE sending a L3 measurement report to the gNB and, in response, receiving an RRC reconfiguration, or may be used to control when the UE starts evaluating the triggering conditions for a CHO associated with a cell that is not in the LTM candidate set.

Even though both the first and the second in this example compare the signal quality of a serving cell to the threshold, the first threshold provides (e.g., only provides) an indication of the serving cell quality, while the second threshold implies the quality of cells within the LTM set. This is because the first threshold enables measurements (and hence mobility) on cells within the LTM set, which would in turn under normal conditions ensure that the best quality cell amongst those within the LTM set is configured as the serving cell. When the serving cell quality goes below the second threshold this implies that all of the cells within the LTM set are below this threshold, and therefore the L3 mobility measurements should be triggered to ensure that the UE can be reconfigured (e.g., by RRC) to a cell outside of the LTM set.

In one embodiment, the second threshold may be compared with the signal quality of multiple cells (e.g., the PCell and some or all of the cells in the LTM set). The UE may, for example, perform an average of N best cells or N best beams (e.g., beams on multiple cells) to derive an LTM set signal quality. This LTM set quality may then be compared to a threshold (e.g., similar to the s-Measure example above), and when this is fulfilled (e.g., when the LTM set quality is above the threshold), the UE can start measuring cells outside the LTM candidate set or evaluating the triggering conditions associated with cells outside the LTM candidate set. In another example, the averaging may also include the current PCell's signal level.

In another example, the UE may enable L3 measurements on cells outside of the LTM set when the number of LTM cells above a certain signal level threshold goes below a certain value. For example, if the number of cells is set to a value of 3 and a threshold is set to a value X, then if there at least 3 LTM candidate cells with a measured signal quality above the threshold value of X, then no measurements need to be performed on cells outside of the LTM set. However, when the number of cells with a measured signal quality above the threshold X goes below 3, then the UE may perform measurements on cells outside of the LTM set in preparation for a potential L3 reconfiguration or conditional reconfiguration. In yet another example, the current PCell may also be considered as part of the number of cells to be compared with the signal level threshold (e.g., for the example above, this could mean that if 2 LTM candidate cells and the PCell are above the threshold value of X, then no measurement is performed on non LTM candidate cells).

In the examples discussed above, the separate conditions (e.g., s-Measure) may be used to control when measurements are performed on cells within the LTM set and outside of the LTM set. In other examples, these conditions may alternatively or additionally be used to control the measurement evaluation type.

In one embodiment, the UE may be configured with one or more measurement events associated with LTM, such as measurement events which are triggered when a candidate cell goes above a threshold. Such an event may be used, for example, to control when L1 CSI measurements are enabled on this candidate cells. In this example, the UE may also be configured with one or more measurement events or conditional reconfigurations used for performing L3 mobility. These may be, but are not limited to, one or more of the existing measurement evens such as A3, A4, A5. When the first condition is met, the UE may evaluate events associated with LTM using measurements performed on LTM candidate cells. When the second condition is met, the UE evaluates events associated with L3M using measurements performed on cells outside of the LTM set and may, in some examples, additionally or alternatively consider measurements performed on cells inside of the LTM set.

In some embodiments, the measurement events may be separate, and may use different triggering conditions and potentially different reporting mechanisms. For example, the LTM events may report using a MAC CE and the L3M events may report using an RRC measurement report. These separate measurement events may, for example, be used to perform intra-CU mobility using LTM measurement events (within the LTM candidate set) and inter-CU mobility using L3M measurement events (outside of the LTM candidate set).

According to one embodiment, when only the first condition is met, the UE may perform measurements and event evaluation associated with LTM and may not perform measurements and event evaluation associated with L3M. This may avoid or minimise a potential race condition whereby both LTM and L3M triggers are received at the same time (potentially being issued by different network nodes and transmitted using different parts of the protocol means the order in which the UE receives the commands may be unknown to the network). In one solution, when the second condition is met, the UE may stop performing measurement event evaluations which are associated with LTM and performs measurement event evaluation associated with L3M. In other words, the evaluation and reporting of LTM events may stop when the evaluation and reporting of L3M starts, which ensures that only one method of mobility is used at any point in time, even though both methods are configured in the UE in parallel. The UE effectively switches between LTM and L3M based on the separate conditions, using different measurements, measurement events, and reporting mechanisms according to the mobility method in use.

In other words, according to certain embodiments, the first threshold may control whether measurements need to be performed or whether the UE may choose not to perform measurements, while the second threshold may control the type of measurement evaluation and reporting performed by the UE. A UE may evaluate using a first set of measurement events (e.g., evaluating candidate cells) and may report using a first reporting method (e.g., MAC CE) when the PCell measurement is above the second threshold, and may evaluate using a second set of measurement events (e.g., evaluating candidate cells and neighbour cells) and may report using a second reporting method (e.g., RRC measurement report) when the PCell measurement is below the second threshold.

In one embodiment, when the second condition is met (or when the UE detects the second condition is no longer met) then the UE may send an indication to the network. This may be transmitted using an RRC measurement report or may be conveyed in an UL MAC CE, for example. This indication is effectively informing the network which set of measurement rules and/or events (i.e., the first or second) are in use in the UE, and allows the network to, for example, stop using LTM triggers for handover while the UE is performing L3 measurement evaluation. This is one way to avoid the network issuing, e.g., a MAC CE sent by a DU to trigger an intra-DU cell change while the CU is preparing an inter-CU cell change using L3. In this example, the UE may continue performing both types of measurement evaluation and reporting, while the network may avoid using one or the other type of handover trigger.

In an embodiment, a third condition may be provided. This may be used such that, for example, the first condition is used to control when measurements, evaluation, and reporting are performed on cells within the LTM set, the second condition is used to control when to perform measurements, evaluation and reporting, used for maintaining the LTM set (e.g., to determine when to add/remove/replace LTM candidates from the set), and the third condition is used to control when to perform measurement, evaluation, and reporting to support L3M.

It is noted that, in other examples, more than three conditions may be provided, in order to enable measurement and evaluation associated with more than three purposes.

According to some example embodiments, a UE may (e.g., may be configured to) perform measurements on the set of cells within the LTM set, derive a first signal quality based on the measurements, and evaluate the signal quality based on a first condition. The UE may (e.g., may be configured to) perform measurements on cells outside of the LTM set, derive a second signal quality, and evaluate the signal quality based on a second condition. When the first and the second conditions are met (e.g., simultaneously met), the UE may (e.g., may be configured to) trigger a measurement report.

In one embodiment, new types of measurement event triggers and/or conditional reconfiguration triggers may be provided, which may for example use one of the conditions as described above to control the measurement event trigger.

According to an embodiment, the measured LTM set quality may be compared to the first condition while the measurements of cells outside of the LTM set may be compared to the second condition. Taking the existing event A5 as an example, this may be triggered when the SpCell goes below a threshold and a neighbour cell goes above a threshold. As another example, the event A3 may be triggered when a neighbour becomes offset better than SpCell. One embodiment may trigger, rather than on SpCell alone, when all cells in the LTM set go below a threshold (i.e., only LTM set cells are considered as described above in terms of determining s-Measure) and a cell outside of the LTM set (a neighbour) goes above a threshold.

In some embodiments, the cells within the LTM set may be averaged, for example using any of the following approaches: (1) SpCell is considered with the same weight as candidate cells. For example, a signal quality is derived using an equal weighted average of N best cells in the LTM set, which may include the SpCell; and/or (2) SpCell may have a greater weight than other cells in the LTM set. For example, an average is calculated using any method of calculating a weighted average and assigning the SpCell a greater weight than other cells.

Another embodiment may use three conditions. For example, an event may be defined which triggers when the SpCell is below a first threshold, the LTM candidate cells are below a second threshold, and the non-LTM (neighbour) cell is above a third threshold.

Alternatively, in an embodiment, a condition on a number of cells may be used, similar to what is described above for s-Measure. For example, the measurement event may trigger when less than 3 cells in the LTE set are above a first threshold, and a cell outside of the LTM set is above a second threshold.

In an embodiment, where separate s-Measures are also used, the UE may perform measurements on both the cells within and outside of the LTM set when the second condition is met, in order to be able to compare the results.

One example embodiment may be directed to a method that may be implemented by a WTRU. The method may include receiving information that indicates: a set of layer 1/layer 2 triggered mobility (LTM) candidate cells, a configuration of a first condition associated with a signal quality of a serving cell, and/or a configuration of a second condition associated with a signal quality of the LTM candidate cells. The method may include performing measurements of the signal quality of the serving cell. Based on the first condition that is associated with a signal quality of the serving cell being satisfied, the method may include performing any one or more of: measurements of the signal quality of the LTM candidate cells, a first measurement evaluation method of the measurements (e.g., performing an evaluation of the measurements of the LTM candidate cells using a first measurement evaluation method), and/or a first measurement reporting method (e.g., reporting the measurements using a first measurement reporting method). Based on the second condition that is associated with a signal quality of the LTM candidate cells being satisfied (e.g., when the first condition and the second condition are satisfied), the method may include performing: measurements of signal quality of cells that are not in the set of the LTM candidate cells, a second measurement evaluation method of the measurements (e.g., performing an evaluation of the measurements of the non-LTM candidate cells using a second measurement evaluation method), and/or a second measurement reporting method (e.g., reporting the measurements of the non-LTM candidate cells using a second measurement reporting method). On condition that a radio quality condition based on the second measurement evaluation method is satisfied, the method may include transmitting a measurement report using the second reporting method.

In an embodiment, the first measurement evaluation method may be or may include layer 1 (L1) measurements. In an embodiment, the first measurement reporting method may be or may include a channel state information (CSI) report.

In an embodiment, the second measurement evaluation method may be or may include layer 3 (L3) measurements. In an embodiment, the second measurement reporting method may be or may include a radio resource control (RRC) measurement report.

In an embodiment, the first condition is satisfied when (e.g., on condition that) the measured signal quality of a primary cell (PCell) is below a first threshold. In an embodiment, the second condition is satisfied when (e.g., on condition that) any one or more of the following occur: the signal quality of all of the LTM candidate cells are below a second threshold, an average signal level of all of the LTM candidate cells is below a third threshold, and/or a signal level of all of the LTM candidate cells is decreasing.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

1. A wireless transmit/receive unit (WTRU), comprising:
circuitry, including any of a transmitter, receiver, processor and memory, the circuitry configured to
receive information indicating (1) a set of layer 1/layer 2 triggered mobility (LTM) candidate cells, (2) a configuration of a first condition based on a signal quality of a serving cell, and (3) a configuration of a second condition based on a signal quality of the LTM candidate cells;
perform measurements of the signal quality of the serving cell; and
based on the first condition being satisfied:
perform any of: (1) first measurements of the signal quality of the LTM candidate cells, (2) a first measurement evaluation method of the first measurements, and (3) a first measurement reporting method;
based on the second condition being satisfied, perform: (1) second measurements of signal quality of cells that are not in the set of the LTM candidate cells, (2) a second measurement evaluation method of the second measurements, and (3) a second measurement reporting method; and
on condition that a radio quality condition based on the second measurement evaluation method is satisfied, transmit a measurement report using the second reporting method.

2. The WTRU of claim 1, wherein the first measurement evaluation method comprises layer 1 (L1) measurements.

3. The WTRU of claim 1, wherein the first measurement reporting method comprises a channel state information (CSI) report.

4. The WTRU of claim 1, wherein the second measurement evaluation method comprises layer 3 (L3) measurements.

5. The WTRU of claim 1, wherein the second measurement reporting method comprises a radio resource control (RRC) measurement report.

6. The WTRU of claim 1, wherein the first condition is satisfied on condition that the measured signal quality of a primary cell (PCell) is below a first threshold.

7. The WTRU of claim 1, wherein the second condition is satisfied on condition that any one or more of the following occur:
the signal quality of all of the LTM candidate cells are below a second threshold;
an average signal level of all of the LTM candidate cells is below a third threshold; and/or
a signal level of all of the LTM candidate cells is decreasing.

8. A method, implemented by a wireless transmit/receive unit (WTRU), the method comprising:
receiving information indicating (1) a set of layer 1/layer 2 triggered mobility (LTM) candidate cells, (2) a configuration of a first condition based on a signal quality of a serving cell, and (3) a configuration of a second condition based on a signal quality of the LTM candidate cells;
performing measurements of the signal quality of the serving cell; and
based on the first condition being satisfied:
performing any of: (1) first measurements of the signal quality of the LTM candidate cells, (2) a first measurement evaluation method of the first measurements, and (3) a first measurement reporting method;
based on the second condition being satisfied, performing: (1) second measurements of signal quality of cells that are not in the set of the LTM candidate cells, (2) a second measurement evaluation method of the second measurements, and (3) a second measurement reporting method; and
on condition that a radio quality condition based on the second measurement evaluation method is satisfied, transmitting a measurement report using the second reporting method.

9. The method of claim 8, wherein the first measurement evaluation method comprises layer 1 (L1) measurements.

10. The method of claim 8, wherein the first measurement reporting method comprises a channel state information (CSI) report.

11. The method of claim 8, wherein the second measurement evaluation method comprises layer 3 (L3) measurements.

12. The method of claim 8, wherein the second measurement reporting method comprises a radio resource control (RRC) measurement report.

13. The method of claim 8, wherein the first condition is satisfied on condition that the measured signal quality of a primary cell (PCell) is below a first threshold.

14. The method of claim 8, wherein the second condition is satisfied on condition that any one or more of the following occur:
the signal quality of all of the LTM candidate cells are below a second threshold;
an average signal level of all of the LTM candidate cells is below a third threshold; and/or
a signal level of all of the LTM candidate cells is decreasing.

15. (canceled)

16. A wireless transmit/receive unit (WTRU), comprising:
circuitry, including any of a transmitter, receiver, processor and memory, the circuitry configured to
receive information indicating a set of layer 1/layer 2 triggered mobility (LTM) candidate cells, a configuration of a first condition, and a configuration of a second condition;
determine a first signal quality based on measurements of a signal quality of the LTM candidate cells;
determine a second signal quality based on measurements of a signal quality of cells that are not in the set of the LTM candidate cells;
determine whether the first signal quality satisfies the first condition;
determine whether the second signal quality satisfies the second condition; and
on condition that the first signal quality satisfies the first condition and the second signal quality satisfies the second condition, transmit a measurement report indicating any of the first signal quality and the second signal quality.

17. The WTRU of claim 16, wherein the first signal quality comprises a measured signal quality of a primary cell (PCell), and wherein the first condition is satisfied on condition that the measured signal quality of a primary cell (PCell) is below a first threshold.

18. The WTRU of claim 16, wherein the second condition is satisfied on condition that the signal quality of any of cells that are not in the set of the LTM candidate cells is above a second threshold.
